(19) United States
(12) Patent Application Publication
(10) Pub. No.: US 2009/0020588 A1
(43) Pub. Date: Jan. 22, 2009

(54) Method for manufacturing product involving solder joining, solder joining apparatus, soldering condition verification method, reflow apparatus, and solder joining method

(75) Inventors: Osamu Saito, Kawasaki (JP); Rie Takada, Kawasaki (JP); Mitsumasa Kojima, Kawasaki (JP); Tetsuji Ishikawa, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/232,386

(22) Filed: Sep. 16, 2008

Related U.S. Application Data
(63) Continuation of application No. PCT/JP2006/306706, filed on Mar. 30, 2006.

(51) Int. Cl. B23K 31/12

(52) U.S. Cl. 228/103; 228/9

(57) ABSTRACT

A method for manufacturing a product involving solder joining wherein components placed on a board on which the components are to be mounted are solder-joined to the board by subjecting the board to reflow heating under prescribed heating conditions, the method comprising: calculating, at each designated site on the board, a component volume that is occupied by the components mounted within a given area; determining the heating conditions in accordance with the calculated component volume; and performing the reflow heating based on the determined heating conditions.

### CROSS REFERENCE TO RELATED APPLICATION

The present application is a continuation application based on International application No. PCT/JP2006/306706, filed on Mar. 30, 2006.

### BACKGROUND

1. Field

The present invention relates to a method for manufacturing a product involving solder joining, such as a printed circuit board produced by mounting components on a printed wiring board (PWB), and to a solder joining apparatus, and more particularly to a method for setting reflow conditions for solder-joining components to such a product.

2. Description of the Related Art

In a reflow process for mounting components on a printed wiring board by solder joining, first the components to be soldered are placed on a solder cream paste applied to the board, and then the entire board is heated in a reflow oven above the melting point of the solder to accomplish the soldering joining. The reflow conditions (oven temperature, circuit board transport speed, air velocity, etc.) as the operating conditions of the reflow oven are set so that solder joints are heated to a temperature not lower than the minimum required temperature but not higher than the component heat resistance temperature.

In a prior art solder joint temperature management method, a thermocouple for measuring the temperature was placed on a sample board equivalent to the product to be manufactured, and the temperature profile was checked and the temperature set value was adjusted by measuring the temperature by actually performing reflow heating.

In another prior art management method, the physical property values of the printed circuit board as well as the physical property values the components were examined in advance and, using the thus examined values, heat analysis simulation was performed to predict the temperature profile in the reflow process and thereby verify whether the required temperature standard was satisfied or not.

Patent document 1: Japanese Patent No. 2782789

Patent document 2: Japanese Unexamined Patent Publication No. H03-256105

Patent document 3: Japanese Unexamined Patent Publication No. 2002-353609

However, making the product sample for actual measurement as described above requires a non-negligible cost for sample production. Furthermore, a lot of labor has had to be expended for the preparatory work from the sample production to the experiment using the reflow oven before the reflow conditions can be set.

On the other hand, heat analysis simulation requires a lot of time to enter the physical property values of the circuit board and the components, not to speak of the analysis itself which is a time-consuming procedure. Furthermore, because of poor accuracy of the simulation, it may often end up having to verity the results by actually making measurements on a product sample after the simulation, and thus the simulation approach has involved many problems in practical application.

Furthermore, in recent years, lead-free BGAs that use lead-free BGA bumps have been increasingly used. Since the melting point of the lead-free BGA is more than 20° C. higher than the conventional BGA having eutectic solder bumps, the task of reflow condition setting becomes even more difficult.

In view of the above problems, it is an object of the method disclosed herein to provide a manufacturing method for manufacturing a product involving solder joining, such as a printed circuit board, wherein provisions are made to be able to determine optimum reflow conditions easily when soldering components to the circuit board by reflow heating, and it is also an object of the apparatus disclosed herein to provide a solder joining apparatus for implementing such a manufacturing method.

### SUMMARY

For solder joining by reflow heating, the reflow conditions, i.e., the heating conditions for reflow, are set so that the reflow temperature, that is, the temperature to which solder joints are heated during reflow heating, remains within a temperature range not lower than the minimum required temperature but not higher than the component heat resistance temperature. The reflow conditions here include, for example, the inside temperature of the reflow oven, the transport speed of the printed circuit board in the reflow oven, and the velocity of the hot air, and refer to the heating conditions for reflow heating of the board.

The reflow temperature is not uniform throughout the board, but there are portions where the temperature is high and portions where the temperature is low, depending on the density of the components mounted. Here, since the reflow temperature is determined by the heat capacity of the board, the reflow temperature at a given site on the board varies depending on the volume of the components mounted at that given site.

In view of this, in the apparatus and method disclosed herein, when solder-joining the components to the board by subjecting the board to reflow heating under prescribed heating conditions, the component volume occupied by the components mounted within a given area is calculated at each designated site on the board, the heating conditions is determined in accordance with the calculated component volume, and the reflow heating is performed based on the thus determined heating conditions.

More specifically, in a method for manufacturing a product involving solder joining disclosed herein, when solder-joining components to a board for mounting thereon by placing the components on the board and by subjecting the board to reflow heating under prescribed heating conditions, the component volume occupied by the components mounted within a given area is calculated at each designated site on the board, the heating conditions is determined in accordance with the calculated component volume, and the reflow heating is performed based on the thus determined heating conditions.

A solder joining apparatus disclosed herein, for solder-joining components to a board for mounting thereon by placing the components on the board and by subjecting the board to reflow heating under prescribed heating conditions, comprises: a component volume calculation unit which calculates, at each designated site on the board, a component volume that is occupied by the components mounted within a given area; and a heating condition determining unit which determines the heating conditions in accordance with the calculated component volume.

A soldering condition verification method disclosed herein, for verifying suitability of soldering conditions for component mounting on a board, comprises: calculating a volume for components placed within a given area on the board; extracting a maximum component volume from the calculated component volume; determining the lowest reflow temperature on the board by using the extracted maximum component volume as a parameter; and verifying the suitability of soldering conditions for the board by comparing the lowest reflow temperature with a temperature required for soldering.

A reflow apparatus disclosed herein, for performing reflow soldering by heating a board on which components are mounted, comprises: a heating mechanism for heating the components; a control unit for controlling the heating mechanism; and a storage unit for storing reflow conditions that the control unit uses when controlling the heating mechanism. Here, the reflow conditions are set in accordance with the volume of components mounted within a given area on the board, and the control unit reads out from the storage unit the reflow conditions stored for the board to be subjected to reflow soldering, and controls the reflow soldering on the board by using the readout reflow conditions.

A solder joining method disclosed herein, for solder-joining components to a board for mounting thereon by placing the components on the board and by subjecting the board to reflow heating under prescribed heating conditions, comprises; calculating, at each designated site on the board, a component volume that is occupied by the components mounted within a given area; determining the heating conditions in accordance with the calculated component volume; and performing the reflow heating based on the determined heating conditions.

The present invention will be described below with reference to the accompanying drawings.

### BRIEF DESCRIPTION OF THE DRAWINGS

FIG. 1 is a graph showing the relationship between component spacing and reflow temperature variation ΔT.

FIG. 2 is a diagram for explaining a component volume calculation range.

FIG. 3 is a graph showing the relationship between component volume and reflow temperature variation ΔT.

FIG. 4 is a diagram for explaining a method for determining reflow conditions.

FIG. 5 is a diagram for explaining a method for determining component volumes allowed under different temperature standards.

FIG. 6 is a block diagram showing the general configuration of a first embodiment of a solder joining apparatus disclosed herein.

FIG. 7 is a flowchart illustrating a reflow condition determining method implemented by the solder joining apparatus shown in FIG. 6.

FIG. 8 is a diagram for explaining a method for determining reflow conditions in first reflow equipment.

FIG. 9 is a diagram for explaining a method for determining reflow conditions in second reflow equipment.

FIG. 10 is a perspective view showing the general construction of a second embodiment of a solder joining apparatus disclosed herein.

FIG. 11 is a block diagram showing the general configuration of the solder joining apparatus shown in FIG. 10.

FIG. 12 is a flowchart illustrating the reflow condition determining method implemented by the solder joining apparatus shown in FIG. 10.

### DESCRIPTION OF THE PREFERRED EMBODIMENTS

Embodiments of a method for manufacturing a product involving solder joining and a solder joining apparatus will be described below.

The solder joining technique contemplated by the present embodiments pertains to a reflow process in which, after placing components on a solder cream paste applied to a board, the board is heated with hot air to a temperature higher than the melting point of the solder to accomplish the solder joining.

As described earlier, for solder joining by reflow heating, the reflow conditions are set so that the reflow temperature remains within a temperature range not lower than the minimum temperature required for solder joining but not higher than the heat resistance temperature of the components. The reflow conditions here refer to the heating conditions under which the printed circuit board with the components mounted thereon is heated in the reflow oven, the main factors including, for example, the inside temperature of the reflow oven, the transport speed of the printed circuit board in the reflow oven, and the velocity of the hot air.

Here, the reflow temperature is not uniform throughout the board, but there are portions where the temperature is high and portions where the temperature is low, depending on the density of the components mounted on the printed board. Accordingly, the reflow conditions must be set so that the highest reflow temperature and the lowest reflow temperature occurring on the board both remain within the range not lower than the minimum temperature required for melting the solder but not higher than the heat resistance temperature of the components.

On the other hand, in the currently predominant reflow oven (not shown), the board is heated by convection using hot air. The reflow temperature is determined by the heat capacity of the board on which components are mounted, and the heat capacity is determined by mass×specific heat, i.e., volume×specific weight×specific heat.

The components mounted on the board are formed from such materials as copper, silicon, epoxy resin, etc. Since it can be assumed the proportions of the materials used are substantially the same between the respective components, the specific weight and the specific heat can be considered substantially the same for each component. Accordingly, the heat capacity of each component mounted on the board to be heated can be expressed by using the volume of each component as a parameter.

Therefore, for each specific site on the circuit board, if the volume of the components mounted at that site is calculated, then the heat capacity at that site can be derived, and the variation of the reflow temperature across the board can thus be determined. The volume of the components mounted at the site on the circuit board is hereinafter referred to as the “component volume”.

When calculating the component volume, it is important to determine how large a range is, where the volume occupied by the components located within is calculated. The reason to determine the range is that the reflow temperature is affected not only by the heat capacity of each specific component to be soldered but also by the heat capacity of the components arranged around it.

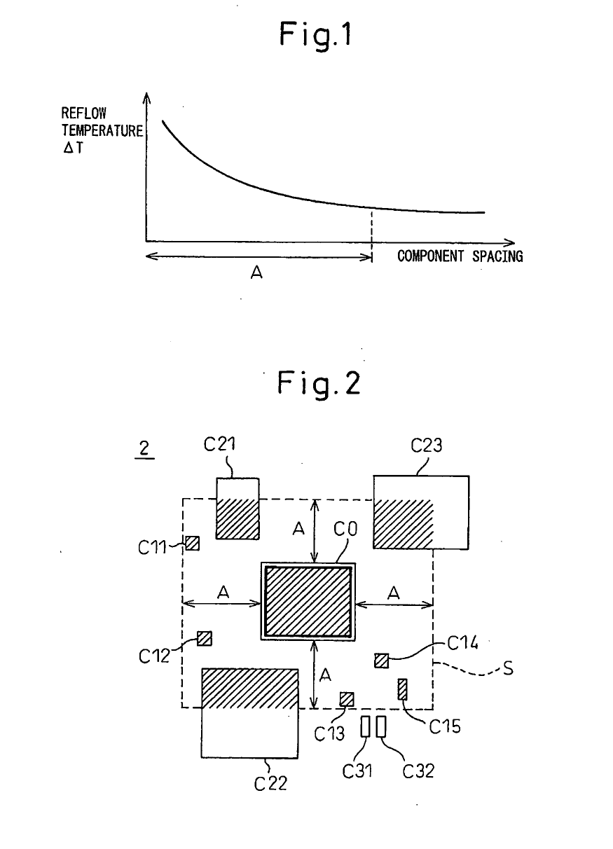

FIG. 1 is a graph showing the correlation between the component spacing, that is a distance between the components, and the reflow temperature variation ΔT on the board. The reflow temperature variation ΔT is hereinafter called “reflow ΔT”. The reflow ΔT refers to the difference between the reflow temperature at each specific component or site and the highest reflow temperature on the board. The portion that exhibits the highest reflow temperature on the board is the portion of the board where no components are mounted, and the reflow temperature of this portion is substantially the same. In other words, it can be considered that the reflow temperature is substantially fixed. On the other hand, as shown in FIG. 1, there is correlation between the reflow ΔT and the component spacing. That is, the reflow ΔT indicates the amount of decrease in the reflow temperature at each specific component, which varies with the spacing to the components arranged around it.

As can be seen from the graph shown in FIG. 1, when the component spacing is greater than a certain distance A, the reflow ΔT remains substantially constant. This means that the reflow temperature at any given site is not affected by the heat capacity of the components spaced at least the distance A away from that site.

Accordingly, the area range within which to calculate the component volume as a parameter defining the reflow temperature at each specific component or site can be determined so as to contain a position spaced the distance A away from the edge of the component for which the reflow temperature is to be obtained. In this way, the reflow ΔT can be calculated by considering the influence of the heat capacity of other components arranged around each specific component or site. Such distance A can vary depending on various conditions, but can be easily determined by experiment.

FIG. 2 is a diagram for explaining the calculation of the component volume, showing a portion of the board on which components are mounted. As described above, in the present embodiment, the total volume of the components located within the distance A from a specific component or site is calculated. More specifically, for each of the components arranged on the board, the component volume occupied by the components located within the distance A from the edge of the specific component is calculated, as shown in FIG. 2. The component volume occupied by the components located within the distance A from the edge of the specific component may be hereinafter referred to as “surrounding area component volume”.

In the example of FIG. 2, when the component for which the reflow temperature is to be obtained is designated as C0, since components C11 to C15 are entirely contained within the area range S defined by the distance A from the edge of the component C0, the volumes of all of these components C11 to C15 are included in the surrounding area component volume.

On the other hand, only portions of components C21 to C23 are contained within the area range S defined by the distance A from the edge of the component C0. More specifically, only hatched portions of the components C21 to C23 are contained within the area range S defined by the distance A from the edge of the component C0. Therefore, the volumes only of the hatched portions of the components C21 to C23 are included in the surrounding area component volume.

Components C31 and C32 are not contained within the area range S defined by the distance A from the edge of the component C0. Therefore, the volumes of the components C31 and C32 are not included in the surrounding area component volume. The volume of the component C0 is of course included in the surrounding area component volume.

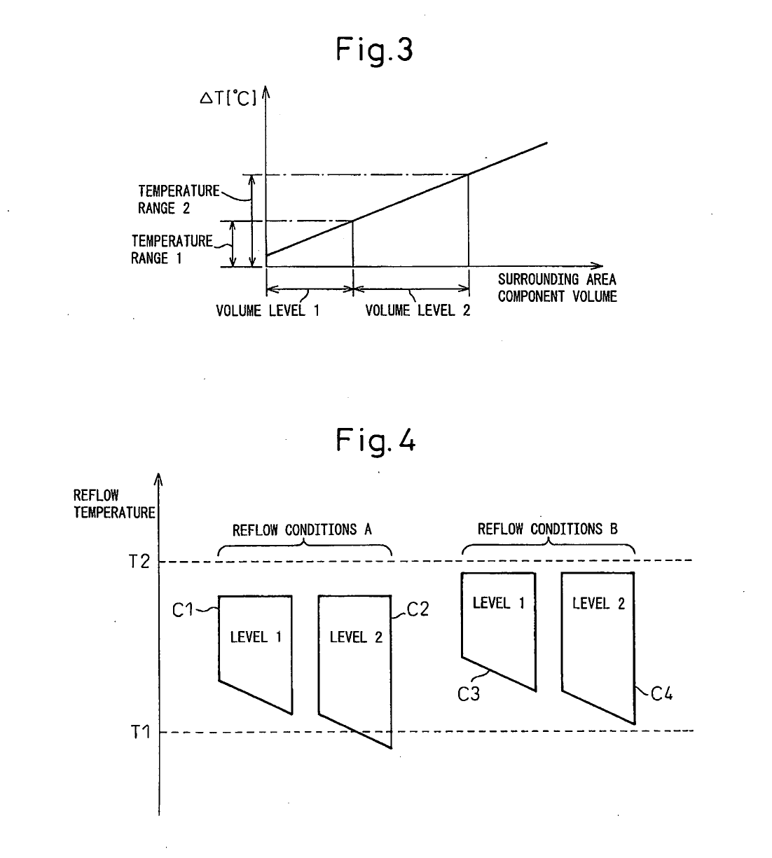

The surrounding area component volume thus calculated by including the volumes of all the components located within the range (distance A) can be regarded as a parameter substantially proportional to the reflow ΔT for the specific site concerned. This will be explained with reference to FIG. 3.

FIG. 3 is a graph showing the relationship between the surrounding area component volume on a given board and the reflow ΔT at each specific site on the board when subjected to reflow heating in a given reflow oven. As shown in FIG. 3, as the surrounding area component volume increases, the reflow ΔT also increases, that is, the amount of decrease in the reflow temperature increases.

In this way, the surrounding area component volume can be used to estimate the reflow temperature difference expected to occur on a given board when heated in a given reflow oven. Accordingly, by using the surrounding area component volume, it can be determined whether the reflow temperature difference expected to occur on the board when heated under given reflow conditions can be held within the temperature range needed for solder joining, and allowable reflow conditions can thus be determined.

Here, by defining various ranges of the reflow temperature variation, and determining the range of the surrounding area component volume for each range of the reflow temperature variation, the surrounding area component volumes can be classified into volume levels corresponding to various levels of the reflow temperature variation.

In the example of FIG. 3, when the surrounding area component volume is, for example, in the range of volume level 2 that exceeds a predetermined volume, the reflow temperature can, at the maximum, vary up to the upper limit of the temperature range 2. On the other hand, when the component volume is in the range of volume level 1 not greater than the predetermined volume, the reflow temperature only varies at the maximum up to the upper limit of the temperature range 1.

FIG. 4 is a diagram for explaining a method for determining reflow conditions. C1 to C4 shown in FIG. 4 each indicate the range of the reflow temperature variation that can occur during the reflow heating of the board at a specific component or site having a given surrounding area component volume.

In FIG. 4, C1 and C2 each indicate the range of the reflow temperature variation that can occur on the board when reflow heating is performed under reflow conditions A. Likewise, C3 and C4 each indicate the range of the reflow temperature variation that can occur on the board when reflow heating is performed under reflow conditions B.

C1 and C3 each corresponds to the boards in which the range of the maximum surrounding area component volume on the board lies within the level 1 shown in FIG. 3. It is assumed that conditions other than the reflow conditions are the same for both C1 and C3. Likewise, C2 and C4 each corresponds to the boards in which the range of the maximum surrounding area component volume on the board is large enough to reach the level 2 shown in FIG. 3. It is assumed that conditions other than the reflow conditions are the same for both C2 and C4.

That is, C1, C2, C3, and C4 show various combinations of the maximum surrounding area component volumes and the reflow conditions, i.e., level 1 and conditions A, level 2 and conditions A, level 1 and conditions B, and level 2 and conditions B, respectively.

Here, if the maximum surrounding area component volumes lie within the same volume level, the lowest reflow temperature varies depending on the value of each individual maximum surrounding area component volume. In each of the ranges C1 to C4 shown in FIG. 4, the lower side slanted downward indicates that the lowest reflow temperature decreases as the maximum surrounding area component volume in each designated volume level increases, while the constant upper side indicates that the highest reflow temperature is constant and independent of the maximum surrounding area component volume.

Here, consider the case where the reflow temperature is controlled between temperatures T1 and T2. In the conditions shown in FIG. 4, when the maximum surrounding area component volume on the board lies within the range defined by the volume level 1, the reflow temperature can be maintained within the temperature range of T1 to T2 whether the reflow conditions A or the reflow conditions B are used.

On the other hand, when the maximum surrounding area component volume lies within the range defined by the volume level 2, if the reflow conditions A are used, the reflow temperature may become lower than the minimum required temperature T1 at a certain site on the board. Therefore, the reflow conditions A cannot be used, and the reflow conditions B must be selected.

By estimating the variation range of the reflow temperature based on the maximum surrounding area component volume, the lowest reflow temperature on the board under the designated reflow conditions can be determined. And by comparing the lowest temperature on the board with the minimum required temperature T1 and determining whether the reflow conditions are suitable or not, the reflow conditions that satisfy the allowable temperature range can be selected.

The allowable range of the reflow temperature varies from product to product, and may also vary depending on soldering conditions, etc. For example, the melting point of lead-free solder is higher than that of eutectic solder. On the other hand, the maximum allowable temperature of reflow, which is dependent on the component heat resistance temperature, etc., is almost uniquely determined irrespective of the type of solder used. As a result, in the case of a product containing both eutectic solder and lead-free solder BGAs, the allowable variation range of the reflow temperature is narrower than that allowed for a product that uses only eutectic solder.

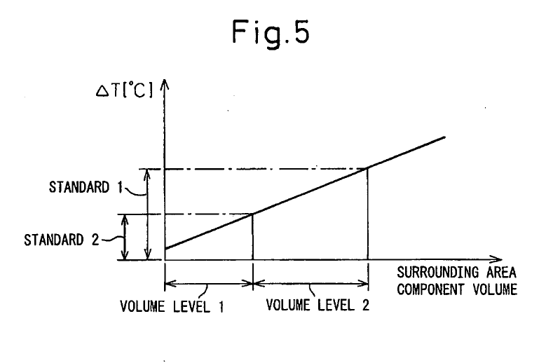

Accordingly, if the allowable range of a maximum surrounding area component volume for each type of solder used is determined based on the relationship between the surrounding area component value and the reflow ΔT shown in FIG. 5, then in the case of a product that uses only eutectic solder, for example, the range of standard 1 shown in FIG. 5 can be taken as the allowable temperature variation range, and therefore, the maximum surrounding area component volume that lies within the range defined by the volume levels 1 and 2 is allowable. On the other hand, in the case of a product containing both eutectic solder and lead-free solder BGAs, for example, since the allowable temperature variation range is equal to the range of standard 2 shown in FIG. 5, which is smaller than the range of standard 1, a good reflow operation can be accomplished only when the maximum surrounding area component volume lies within the range defined by the volume level 1.

In this way, when determining the applicable reflow conditions based on the maximum surrounding area component volume, it is desirable to check whether a lead-free BGA is used in the product to be subjected to reflow heating.

Further, since the reflow temperature is also affected by the thickness of the board, it is desirable to consider the thickness of the board as well.

As described above, the reflow conditions can be determined based on the maximum surrounding area component volume, the thickness of the board, the use or nonuse of a lead-free BGA, etc. The reflow conditions may be determined, for example, by using a reflow condition mapping table, such as Table 1 shown below, and selecting allowable reflow conditions from among a plurality of sets of predetermined reflow conditions A to D.

In the example of Table 1, the maximum surrounding area component volumes are classified into two levels, volume level 1 and volume level 2, by using a predetermined reference volume, and the board thicknesses are also classified into two levels, thickness level 1 and thickness level 2, according to whether the thickness is greater than a predetermined thickness. In this way, in the example of Table 1, the thickness of the board is also considered as a factor that can cause a change in the heat capacity. Then, the various combinations of the volume levels and thickness levels are mapped to the reflow conditions A to D that can be used when soldering components to the board for two cases where a lead-free BGA is used or not.

### [Table 1]

TABLE 1

| | | SURROUNDING AREA | |
|---|---|---|---|
| | | COMPONENT VOLUME | |
| | BOARD | VOLUME | VOLUME |
| LEAD-FREE BGA | THICKNESS | LEVEL 1 | LEVEL 2 |
| NOT USED | THICKNESS | REFLOW | REFLOW |
| | LEVEL 1 | CONDITIONS | CONDITIONS |
| | | A | B |
| | THICKNESS | REFLOW | REFLOW |
| | LEVEL 2 | CONDITIONS | CONDITIONS |
| | | C | D |
| USED | THICKNESS | REFLOW | |
| | LEVEL 1 | CONDITIONS | |
| | | A | |
| | THICKNESS | REFLOW | |
| | LEVEL 2 | CONDITIONS | |
| | | C | |

In the example of Table 1, in the case of the volume level 1, the reflow can be performed using the reflow conditions A if the thickness level is 1, and using the reflow conditions C if the thickness level is 2, regardless of whether lead-free solder is used or not. Accordingly, in the case of a board whose maximum surrounding area component volume lies within the volume level 1, the applicable reflow conditions can be selected by using the board thickness level as a parameter.

On the other hand, in the case of the volume level 2, when lead-free solder is not used, the reflow can be performed using the reflow conditions B if the thickness level is 1, and using the reflow conditions D if the thickness level is 2. However, when lead-free solder is used, suitable reflow conditions cannot be obtained regardless of the thickness level. In this way, in the example of Table 1, when the maximum surrounding area component volume of the board is the level 2, the reflow conditions must be selected by considering not only the thickness level but also the use or nonuse of lead-free solder.

As described above, the reflow conditions for each board can be set in advance in corresponding relationship to the combination of the volume level and thickness level. Such correspondence can be predefined by taking into account the determination as to whether the reflow temperature variation (reflow ΔT) that occurs when reflow heating is performed under the selected reflow conditions remains within the allowable temperature range that is determined based on the use or nonuse of a lead-free BGA.

In the described calculation method for the surrounding area component volume, the component volume occupied by the components located within the distance A from the edge of each designated component mounted on the board has been calculated.

However, it is apparent that a similar effect can be achieved if the component volume is calculated that is occupied by the components located within a given area centered around each designated site on the board, rather than each designated component mounted on the board. The area within which to calculate the component volume can be determined in advance as an area about the same size as the area within which the component volume is calculated for each designated component mounted on the board.

In the above example of the reflow condition determining method, the applicable reflow conditions have been selected from among the plurality of sets of predetermined reflow conditions by using the reflow condition mapping table. But, instead of or in addition to that, the physical property values defining the reflow conditions may be determined using a prescribed calculation equation based on the maximum surrounding area component volume and/or the board thickness.

Since the heat capacity at each specific site on the board is proportional to the surrounding area component volume and board thickness at that site, the reflow conditions can be determined by determining the reflow oven temperature T in accordance with the following equation (1), for example, based on the maximum surrounding area component volume V and the board thickness D.

T=A×V+B×D+C (1)

In equation (1), A, B, and C are predetermined constant calculation parameters. Using this method, the temperature profile for reflow heating can be controlled in a more meticulous manner. The constants A, B, and C can be obtained by experiment, etc.

Further, using the thus calculated surrounding area component volume and board thickness as parameters, the minimum reflow temperature Tmin on the board under predetermined reflow conditions may be determined based on experimental values or in accordance with a calculation equation such as equation (2) shown below. Suitable reflow conditions may be selected by comparing the minimum reflow temperature Tmin with the temperature required for soldering and thereby determining whether the reflow conditions are suitable for use.

Tmin=Tmax−E×V (2)

In equation (2), E is a predetermined constant calculation parameter, and Tmax is the maximum reflow temperature as a constant predetermined in accordance with the thickness D for each set of reflow conditions.

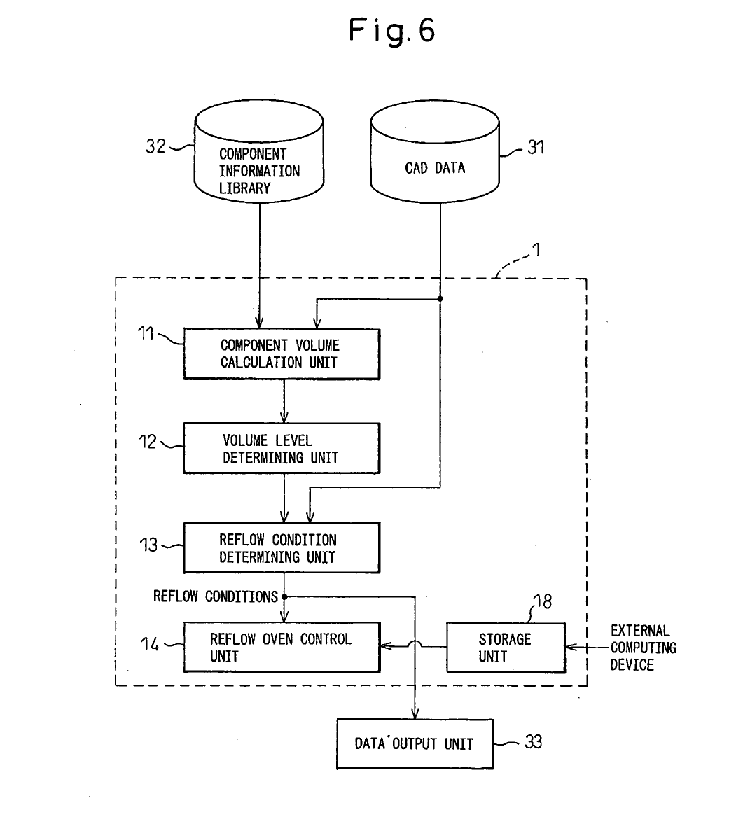

Preferred embodiments of a solder joining apparatus and a method for manufacturing a product involving solder joining disclosed herein will be described in detail below with reference to FIGS. 6 to 12.

FIG. 6 is a block diagram showing a configuration of a portion responsible for the operation and control of one embodiment of the solder joining apparatus disclosed herein.

In the following description, the product involving solder joining will be described by taking as an example a printed circuit board produced by solder-joining electrical components such as electronic components onto the surface of a printed wiring board (PWB). The electrical components is hereinafter referred to as “components”.

Further, the solder joining apparatus 1 shown in FIG. 6 will be described by taking as an example a reflow apparatus in which, after placing the components on a solder cream paste applied to the printed wiring board, the board is heated in a reflow oven (not shown) with hot air to a temperature higher than the melting point of the solder to accomplish the solder joining.

As shown in FIG. 6, the solder joining apparatus 1 according to the present embodiment comprises a component volume calculation unit 11, a volume level determining unit 12, a reflow condition determining unit 13 for setting reflow conditions for the reflow oven, and a reflow oven control unit 14 for controlling the reflow oven in accordance with the above set reflow conditions.

The component volume calculation unit 11 calculates, for each designated component mounted on the printed wiring board, the surrounding area component volume occupied by the components, including the designated component itself, located within the distance A from the edge of the designated component, as previously described with reference to FIG. 2. Here, the component volume calculation unit 11 can calculate the surrounding area component volume based on placement information pertaining to the arrangement of components on the board, contained in CAD data 31 which is design data of the printed circuit board as the product, and on component dimension information prestored in a database such as a component information library 32.

Further, the component volume calculation unit 11 may calculate, as described earlier, the surrounding area component volume that is occupied by the components located within a given area centered around each designated site on the circuit board, rather than each designated component.

The volume level determining unit 12 selects the maximum surrounding area component volume from among the surrounding area component volumes calculated for the various components or sites on the printed wiring board, and takes the maximum surrounding area component volume as the volume level which serves as a measure of the reflow temperature variation on the printed circuit board.

The reflow condition determining unit 13 determines the reflow conditions in accordance with the thus determined volume level. More specifically, any one of the factors defining the reflow conditions, such as the inside temperature of the reflow oven, the transport speed in the reflow oven, and the velocity of the hot air, or all of these factors are determined. Then, the reflow condition determining unit 13 supplies the thus determined reflow conditions either directly to the reflow oven control unit 14 to control the reflow oven through the reflow oven control unit 14, or to a data output unit 33 such as a display unit or a printer for use by an operator to operate the reflow oven.

The above component elements for setting the reflow conditions, that is, the component volume calculation unit 11, the volume level determining unit 12, and the reflow condition determining unit 13, may be implemented as a single or a plurality of software modules operating on an information processor to carry out the respective functions, or may be implemented as a single or a plurality of dedicated hardware modules.

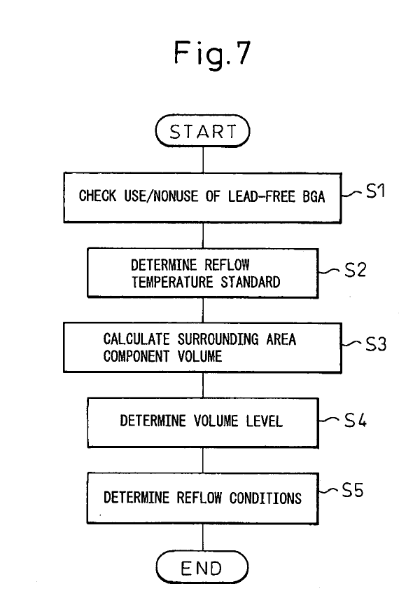

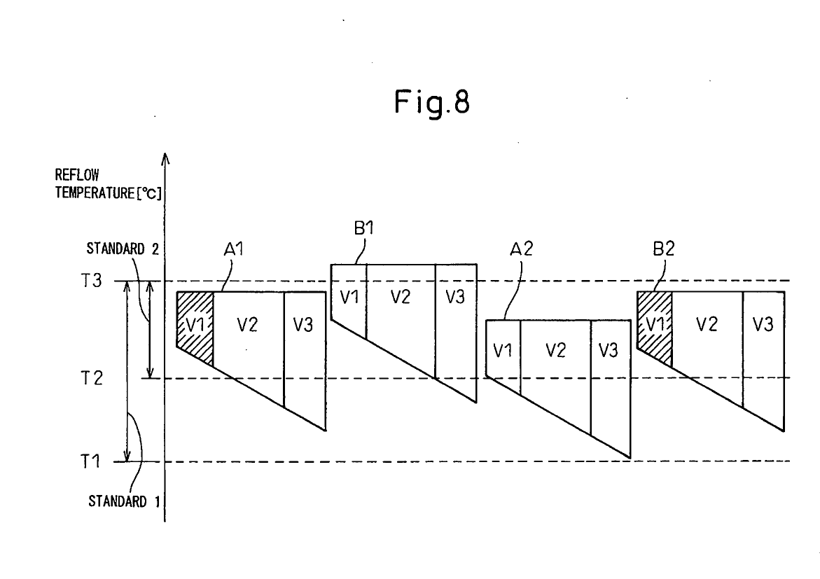

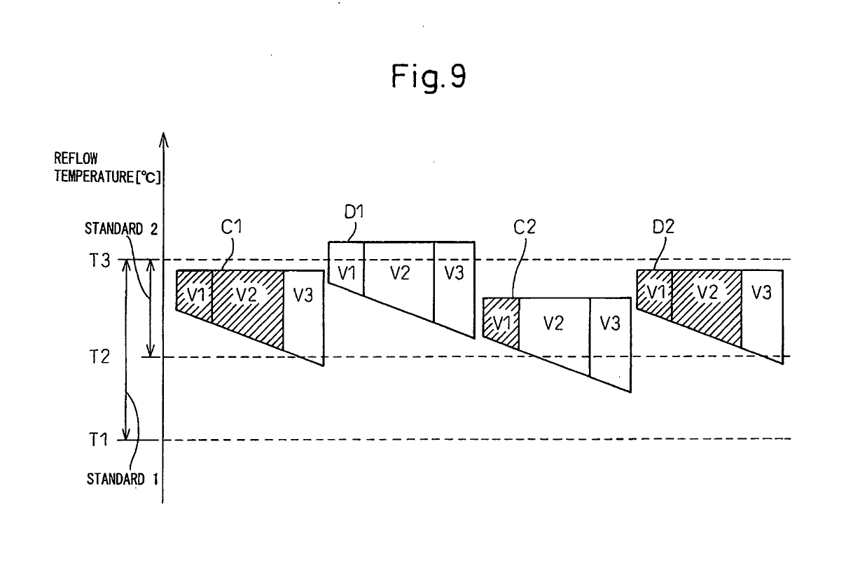

The reflow condition determining method implemented by the solder joining apparatus 1 shown in FIG. 6 will be described below with reference to the flowchart of FIG. 7 and the explanatory diagrams shown in FIGS. 8 and 9.

In step S1, the reflow condition determining unit 13 detects lead-free BGA mounting information from among the printed circuit board design data contained in the CAD data 31, and checks whether any lead-free BGA is used on the printed circuit board and whether eutectic solder and lead-free solder are used in a mixed manner. Then, in step S2, the reflow condition determining unit 13 determines applicable reflow temperature standard based on whether a lead-free BGA is used or not.

For example, let T1 denote the minimum required reflow temperature for a BGA having conventional eutectic solder bumps, T2 the minimum required reflow temperature for a lead-free BGA, and T3 the component heat resistance temperature. Then, reflow temperature standard 1 that covers the reflow temperatures from T3 to T1 is applied for a BGA having eutectic solder bumps. On the other hand, when a lead-free BGA is used, since the minimum required temperature T2 of the lead-free BGA is 20° C. higher than the minimum required temperature T1 of the BGA having eutectic solder bumps, reflow temperature standard 2 that covers the reflow temperatures from T3 to T2 is applied, the allowable temperature variation range thus being narrower than the reflow temperature standard 1 applicable when only eutectic solder is used.

In step S3, the component volume calculation unit 11 calculates the surrounding area component volume, based on the component placement information contained in the CAD data 31 and on the component dimension information prestored in a database such as the component information library 32.

In step S4, the volume level determining unit 12 selects the maximum surrounding area component volume from among the surrounding area component volumes calculated in step S3, and takes it as the volume level specific to the printed circuit board.

In step S5, the reflow condition determining unit 13 determines the applicable reflow conditions from among the plurality of sets of predetermined reflow conditions, based on the reflow temperature standard determined in step S2, the volume level specific to the printed circuit board determined in step S4, and the board thickness information contained in the CAD data 31.

The performance of reflow equipment differs depending on the class of equipment used. For example, the range of the reflow temperature variation occurring on the printed circuit board tends to become smaller in higher performance reflow equipment. Further, since the physical quantities defining the reflow conditions also differ depending on the reflow equipment used, the reflow condition determining unit 13 must set the reflow conditions differently for different reflow equipment. It is assumed here that two types of reflow equipment are used, of which the first reflow equipment is a standard performance type and the second reflow equipment is a high performance type.

FIG. 8 is a diagram for explaining a method for determining reflow conditions in the first reflow equipment. FIG. 8 shows reflow temperature variation ranges that occur when two kinds of boards differing in thickness are subjected to reflow heating under different reflow conditions A and B. The thicknesses 1 and 2 of the two printed circuit boards used here are 1.6 mm and 2.4 mm, respectively.

In the example of FIG. 8, the range A1 indicates the reflow temperature range when the board of thickness 1 is heated under the reflow conditions A, the range B1 indicates the reflow temperature range when the board of thickness 1 is heated under the reflow conditions B, the range A2 indicates the reflow temperature range when the board of thickness 2 is heated under the reflow conditions A, and the range B2 indicates the reflow temperature range when the board of thickness 2 is heated under the reflow conditions B. In this way, in the example of FIG. 8, four kinds of conditions are set. Here, the reflow conditions A and the reflow conditions B are both the reflow conditions specific to the reflow equipment considered in the example of FIG. 8.

Three volume levels, V1, V2, and V3, are set for each of the ranges A1, A2, B1, and B2.

The ranges A1 and A2 and the ranges B1 and B2 indicate the reflow temperature variation ranges for the boards of thicknesses 1 and 2, respectively, and it is shown that each reflow temperature variation range increases as the volume level of the board increases from V1 to V3, that is, the maximum surrounding area component volume increases.

When only eutectic solder is used as the solder, standard 1, i.e., the reflow temperature range T1-T3, is employed as the temperature standard. In this case, the lowest reflow temperature in each of A1, A2, B1, and B2 is above the minimum required temperature T1 defined in the standard 1, whatever the volume level is. However, in the case of B1, it is shown that the portion that exhibits the highest reflow temperature on the board may exceed T3 which defines the component heat resistance temperature.

On the other hand, when temperature standard 2 (T2-T3) applicable to a lead-free BGA is employed, if the reflow conditions A are used, the reflow temperature will remain within the specified range in the case of the volume level V1 shown by hatching in A1 in FIG. 8. It is also shown that, if the reflow conditions B are used, the reflow temperature will remain within the specified range in the case of the volume level V1 shown by hatching in B2. In the case of the volume levels V2 and V3 in A1 and B2, and in the case of A2, it is shown that the portion that exhibits the lowest reflow temperature on the board may be lower than the required temperature T2, resulting in an inability to perform reflow.

FIG. 9 is a diagram for explaining a method for determining reflow conditions in the second reflow equipment. The ranges C1, D1, C2, and D2 shown in FIG. 9 indicate the reflow temperature ranges when two kinds of printed circuit boards differing in thickness, with volume levels varying from V1 to V3, are subjected to reflow heating under different reflow conditions C and D. Here, the range C1 indicates the range when the board of thickness 1 is heated under the reflow conditions C, the range D1 indicates the range when the board of thickness 1 is heated under the reflow conditions D, the range C2 indicates the reflow temperature range when the board of thickness 2 is heated under the reflow conditions C, and the range D2 indicates the range when the board of thickness 2 is heated under the reflow conditions D.

It can be seen that when the eutectic solder temperature standard 1 (T1-T3) is employed, if the reflow conditions C are used, the reflow temperature will remain within the temperature range T1-T3 required of the board for all the volume levels V1 to V3 and for both thicknesses 1 and 2 (see the ranges C1 and C2).

On the other hand, it is shown that when temperature standard 2 (T2-T3) applicable to a lead-free BGA is employed, if the reflow conditions C are used, the reflow temperature will remain within the specified range in the case of the volume level V1 and thickness 1 (see the range C1), and if the reflow conditions D are used, the reflow temperature will remain within the specified range in the case of the volume level V1 and thickness 2 (see the range D2).

In view of the above, the circuit boards are classified into two groups according to their thickness levels, i.e., thickness level 1 not thicker than 1.8 mm and thickness level 2 thicker than 1.8 mm, and a reflow condition mapping master table is constructed as shown in Table 2 below in which the various combinations of the volume levels and thickness levels are mapped to the reflow conditions A to D that can be used when soldering components to the board for two cases whether a lead-free BGA is used or not.

### [Table 2]

TABLE 2

| LEAD- | | | | | | | |
|---|---|---|---|---|---|---|---|
| FREE | THICKNESS | REFLOW OVEN 1 | | | REFLOW OVEN 2 | | |
| BGA | LEVEL | V1 | V2 | V3 | V1 | V2 | V3 |
| NOT | 0-1.8 mm | CONDITIONS | CONDITIONS | CONDITIONS | CONDITIONS | CONDITIONS | CONDITIONS |
| USED | | A | A | A | C | C | C |
| | 1.9 mm - | CONDITIONS | CONDITIONS | CONDITIONS | CONDITIONS | CONDITIONS | CONDITIONS |
| | | A | A | A | C | C | C |
| USED | 0-1.8 mm | CONDITIONS | | | CONDITIONS | CONDITIONS | |
| | | A | | | C | C | |
| | 1.9 mm - | CONDITIONS | | | CONDITIONS | CONDITIONS | |
| | | B | | | C | D | |

The reflow condition determining unit 13 can uniquely determine the applicable reflow conditions by referring to the reflow condition mapping master table based on the reflow temperature standard determined in step S2, the volume level specific to the printed circuit board determined in step S4, and the thickness level of the board thickness information contained in the CAD data 31.

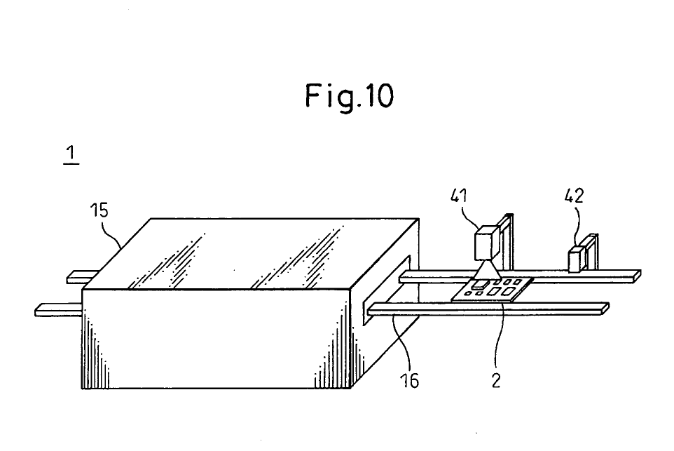

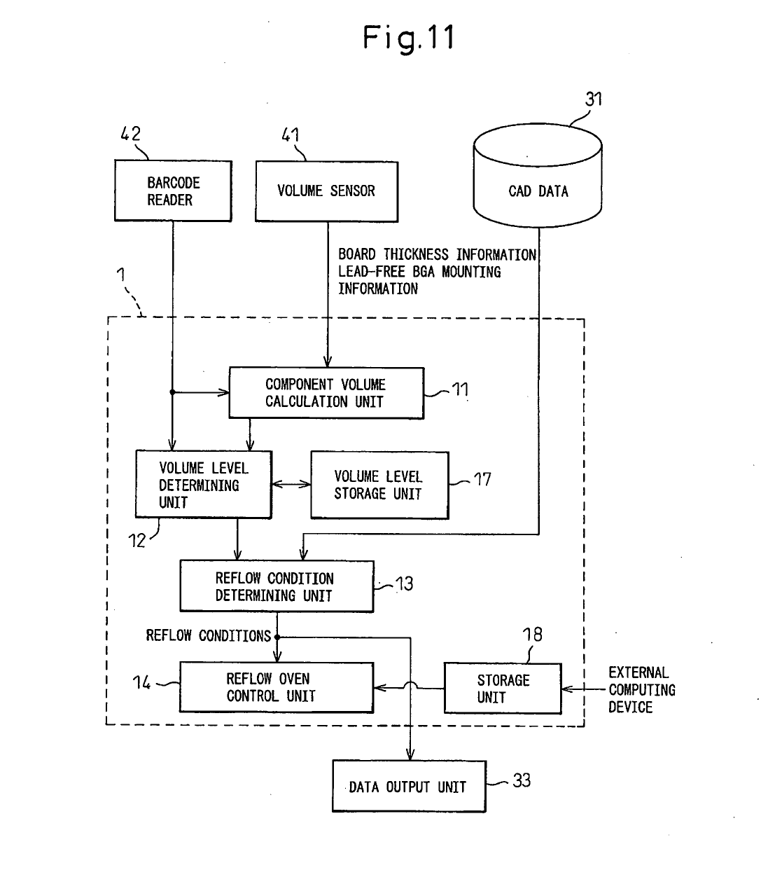

FIG. 10 is a perspective view showing the general construction of a second embodiment of a solder joining apparatus disclosed herein, and FIG. 11 is a block diagram showing the general configuration of the solder joining apparatus shown in FIG. 10.

In the embodiment shown in FIG. 6, upstream information such as the CAD data 31 and component library 32 is used in order to calculate the surrounding area component volume. By contrast, in the present embodiment, a noncontact volume sensor 41 such as a laser is provided above the path of a transport mechanism (conveyor, etc.) 16 that transports the board 2 to the reflow oven 15, and the surrounding area component volume is calculated for each designated site on the printed circuit board.

Here, the noncontact volume sensor 41 scans across the surface of the board 2, for example, with a laser beam, and detects the height of the surface of the circuit board 2, or the height of a component, to detect the volume occupied by the components mounted at each designated site on the board 2.

The solder joining apparatus 1 may further includes a barcode reader 42 for reading the barcode on the product being transported on the conveyor 16 and thereby identifying the part number of the product. Once the surrounding area component volume on a given product is detected, the volume level determined for that product is stored. Then, when performing solder joining on the same product next time, the barcode reader 42 reads the barcode on the product to check whether the product is the same one whose surrounding area component volume has previously been detected. If its surrounding area component volume has previously been detected, the reflow conditions may be set using the stored volume level. For this purpose, the solder joining apparatus 1 is provided with a volume level storage unit 17 for storing the volume level determined by the volume level determining unit 12 for the product.

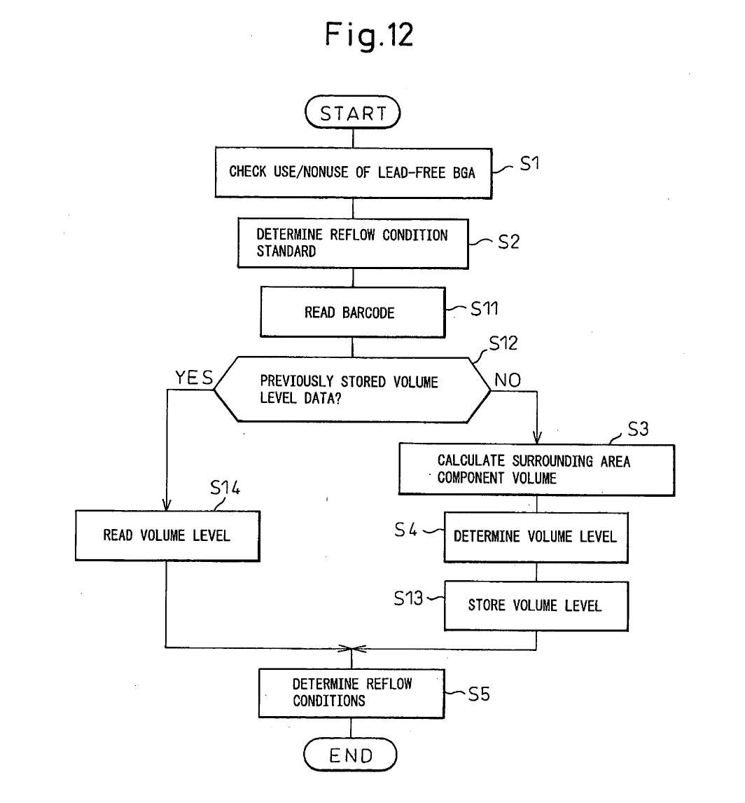

FIG. 12 is a flowchart illustrating the reflow conditioning determining method implemented by the solder joining apparatus shown in FIG. 10. In steps S1 and S2, the reflow condition determining unit 13 checks whether a lead-free BGA is contained or not, and determines the applicable reflow temperature standard accordingly.

In step S11, the barcode reader 42 reads the barcode on the board 2 being transported on the conveyor 16. In step S12, the component volume calculation unit 11 and the volume level determining unit 12 check whether the volume level has previously been determined for the product having the same part number as the board whose barcode has just been read.

If the volume level has not yet been determined, the process proceeds to step S3, and the component volume calculation unit 11 calculates the surrounding area component volume at each designated site on the circuit board 2 from the surface geometric data of the board 2 read by the noncontact volume sensor 41. Then, in step S4, the volume level determining unit 12 determines the volume level specific to the printed circuit board, and in step S13, the thus determined volume level is stored in the volume level storage unit 17 by being associated with the product's part number. Then, in step S5, the reflow conditions are determined using the thus determined volume level.

On the other hand, if it is determined in step S12 that the volume level has previously been determined, the volume level determining unit 12 reads from the volume level storage unit 17 the volume level stored in association with the product's part number. Then, in step S5, the reflow conditions are determined using the thus readout volume level.

In the embodiments shown in FIGS. 6 and 10, the calculation of the surrounding area component volume and the determination of the reflow conditions have been done in the solder joining apparatus 1, but the calculation of the surrounding area component volume and the determination of the reflow conditions according to the above-described method need not necessarily be done in the solder joining apparatus 1.

Instead, processing for the calculation of the surrounding area component volume and the determination of the reflow conditions for the product to be subjected to reflow heating may be carried out using an external computing device that can make use of the component information library 32, CAD data 31, volume sensor 41, etc.

In that case, a storage unit 18 for storing the reflow conditions determined as described above is included in the solder joining apparatus 1. Then, when performing the reflow soldering of the components to the circuit board 2 by using the solder joining apparatus 1, the reflow oven control unit 14 in the solder joining apparatus 1 may read out the reflow conditions applicable to the board 2 from the storage unit 18, and may control the reflow soldering of the components to the circuit board 2 based on the readout reflow conditions.

While the present invention has been described with reference to the preferred embodiments selected only for illustrative purposes, it is apparent to those skilled in the art that various modifications, omissions, and departures can be made to these embodiments without departing from the spirit and scope of the present invention. Further, it is to be understood that the terms used in the appended claims are not limited to the specific meanings used in the embodiments described in this specification.

What is claimed is:

1. A method for manufacturing a product wherein components placed on a board on which said components are to be mounted are solder-joined to said board by subjecting said board to reflow heating under prescribed heating conditions, said method comprising:
calculating, at a designated site on said board, a volume of components which occupy within a given area;
determining a heating condition in accordance with said calculated component volume; and
performing said reflow heating based on said determined heating condition.

2. A method for manufacturing a product as claimed in claim 1, wherein said heating condition is determined in accordance with a maximum value among said calculated component volume.

3. A method for manufacturing a product as claimed in claim 1, wherein said heating condition is determined in accordance with said calculated component volume and a thickness of said board.

4. A method for manufacturing a product as claimed in claim 1, wherein said component volume is calculated within said given area centered around at least one of said components mounted on said board.

5. A method for manufacturing a product as claimed in claim 4, wherein said given area is set so as to extend up to a position a prescribed distance away from an edge of said at least one component, wherein
a minimum component spacing beyond which a temperature generated during the reflow heating of the solder applied to said board becomes substantially independent of the spacing between said components is determined in advance as said prescribed distance.

6. A method for manufacturing a product as claimed in claim 1, wherein said component volume is calculated based on placement data which defines the placement of said components on said board.

7. A method for manufacturing a product as claimed in claim 1, wherein with said components placed on a mounting surface of said product, a height at each designated site on said board is detected, and
said component volume is calculated by using said height detected at each designated site on said board.

8. A solder joining apparatus for solder-joining components to a board for mounting thereon by placing said components on said board and by subjecting said board to reflow heating under prescribed heating conditions, comprising:
a component volume calculation unit which calculates, at each designated site on said board, a component volume which is occupied by said components mounted within a given area; and
a heating condition determining unit which determines said heating conditions in accordance with said calculated component volume.

9. A solder joining apparatus as claimed in claim 8, wherein said heating condition determining unit determines said heating conditions in accordance with a maximum value of said calculated component volume.

10. A solder joining apparatus as claimed in claim 8, wherein said heating condition determining unit determines said heating conditions in accordance with said calculated component volume and a known thickness of said board.

11. A solder joining apparatus as claimed in claim 8, wherein said component volume calculation unit calculates said component volume within said given area centered around at least one of said components mounted on said board.

12. A solder joining apparatus as claimed in claim 8, wherein said component volume calculation unit calculates said component volume based on placement data which defines the placement of said components on said board and which is designed for said board.

13. A solder joining apparatus as claimed in claim 8, further comprising a sensor which detects a height at each designated site on said board with said components placed on a mounting surface of said board, and wherein
said component volume calculation unit calculates said component volume by using said height detected at each designated site on said board.

14. A soldering condition verification method for verifying suitability of soldering conditions for component mounting on a board, comprising:
calculating a volume for components placed within a given area on said board;
extracting a maximum component volume from said calculated component volume;
determining the lowest reflow temperature on said board by using said extracted maximum component volume as a parameter; and
verifying the suitability of soldering conditions for said board by comparing said lowest reflow temperature with a temperature required for soldering.

15. A soldering condition verification method as claimed in claim 14, wherein said component volume is calculated by taking the thickness of said board into account.

16. A reflow apparatus for performing reflow soldering by heating a board on which components are mounted, comprising:
a heating mechanism which heats said components;
a control unit which controls said heating mechanism; and
a storage unit which stores reflow conditions which said control unit uses when controlling said heating mechanism, and wherein
said reflow conditions are set in accordance with the volume of components mounted within a given area on said board, and
said control unit reads out from said
storage unit said reflow conditions stored for said board to be subjected to reflow soldering, and controls said reflow soldering on said board by using said readout reflow conditions.

17. A reflow apparatus as claimed in claim 16, wherein the volume of components mounted within each given area on said board is calculated, and a reflow temperature applicable to a component volume having a maximum value among said calculated component volumes is compared with a temperature required for soldering, and wherein said reflow conditions are chosen so that said reflow temperature is not lower than said required temperature.
